(19) United States
(12) Patent Application Publication
(10) Pub. No.: US 2012/0053805 A1
(43) Pub. Date: Mar. 1, 2012

(54) METHODS FOR DETECTION OF DRIVING CONDITIONS AND HABITS

(75) Inventor: Ramanamurthy Dantu, Richardson, TX (US)

(73) Assignee: The University of North Texas, Denton, TX (US)

(21) Appl. No.: 13/220,420

(22) Filed: Aug. 29, 2011

Related U.S. Application Data
(60) Provisional application No. 61/378,244, filed on Aug. 30, 2010.

(51) Int. Cl. G06F 19/00

(52) U.S. Cl. 701/70

(57) ABSTRACT

A method for detecting and analyzing driving performance and habits as well as road conditions utilizes a smartphone having an accelerometer and a microphone. Acceleration in the x, y, and z axis can be measured as a function of time and at particular velocities to provide valuable information about driver habits, vehicle performance, and road conditions.

This application claims priority to U.S. Provisional Patent Application Ser. No. 61/378,244, entitled Methods for Detection of Driving Conditions and Habits, filed on Aug. 30, 2010, the entire content of which is hereby incorporated by reference.

### BACKGROUND

This disclosure pertains to methods for detecting and analyzing driving conditions and habits, including road conditions, using a smartphone equipped with an accelerometer and a microphone.

With the fast-paced society created today, people are obsessed with arriving at each destination the fastest, and getting back home as quickly as possible. But is this fast-paced lifestyle putting people in harm's way? Are they ignoring safety while driving, or even unaware of hazardous road conditions that can lead to potential accidents? Such accidents not only damage vehicles, hurt driving records and put health at risk, but also endanger many drivers who are in the same vicinity. Today, it is said that having a mobile phone in the car increases the chance of an accident. But what if a mobile phone could ultimately decrease the chance of being involved or even creating a wreck on the road? In recent years, there has been a tremendous growth in smartphones embedded with numerous wireless sensors such as accelerometers, GPS, magnetometers, multiple microphones and even cameras. The scope of wireless sensor networks has expanded into many application domains that can provide users with new functionalities previously unheard of.

Experimental automobiles in the past have included certain sensors to record data preceding test crashes. After analysis, crash scenarios are stored and analyzed with real time driving data to recognize a potential crash and try to prevent it. These sensors can cost thousands of more dollars for an already expensive, luxury automobile. This is not convenient for an average person who buys an affordable mid-sized vehicle focused primarily on family safety. Sacrificing luxury for safety accommodations is something all buyers have to endure when shopping for a vehicle that can balance their family's health with a reasonable price tag. With the economy not flourishing as in the past, people are always looking for alternatives that provide an efficient means of support without cutting corners. Using a mobile phone as one of these alternatives can provide the critical safety requirements people so vigorously seek at a most affordable price as this device is already bound to most of their lives. With these new smartphones equipped with sensors capable of working together to formulate complex results, the door has been opened for new low-cost safety enhancements in intelligent transportation systems.

There are over 10 million car accidents reported in the United States each year. Most car manufacturers today focus primarily on protecting their drivers during an accident. Automobiles now include various safety features, such as airbags, seat belts and anti-lock brakes meant to protect the driver during the span of an accident. But isn't the best protection against an automobile accident the ability to prevent it altogether? Prevention will not only save thousands of lives, but also save the time and money that is consistently flushed into the many legal protocols that follow an accident.

Vehicle degradation is an inevitable consequence of owning and operating an automobile. A car's health is always at risk as it is susceptible to external environmental factors, such as the roads and other cars, and also to internal factors, such as aging parts and strenuous driving behaviors. The resources available to provide a quick fix do not always work and sometimes comes too late to even use. By using a device that is already integrated into people's daily lives which can help to prevent most automobile catastrophes not only seems logical, but almost revolutionary as a dependence on car manufacturers to provide a safe driving experience is lifted. As smartphones are easily available and widely used, the intuitive functionality presented by a mobile phone to detect vehicle safety problems has an ever expanding practicable design base with limited overhead cost.

Sensor-aided driving is a fairly new study but some work has been accomplished in the form of theoretical research to development in a practical design. “Nericell” is a system researched and developed by Microsoft that detects potholes, honking, bumps, and brakes using smartphones (Mohan et al. 2008). For detection it uses various sensors like the microphone, GPS, accelerometer and GSM radio. Nericell has been tested for its practical application use on the roads of Bangalore, India.

“Pothole Patrol” is another system that monitors the road conditions using GPS and an accelerometer. The system was deployed for testing in taxis which blanketed the city of Boston to identify uneven road surfaces. Their implementation was successful as it was able to identify potholes of various sizes throughout the city (Ericksson et al. 2008).

Dai focused on a driver's ability to perform on the road (Dai et al. 2010). They proposed a technique using a mobile smartphone to detect various driving patterns of the operator that mimics the habits of a drunk driver. When these patterns are in variable sync, it was assumed the driver was intoxicated and authorities were notified. Results showed promise as the system achieved a very high accuracy rate while employing an energy-efficient technique.

The measurement and analysis of driving habits and road conditions is complex and involves may different variables, but ideally it should be accomplished using only a single measuring device rather than external sensors placed in numerous locations around a vehicle.

### SUMMARY

The present invention relates generally to methods for detecting and analyzing driving conditions and habits using a smartphone.

Mobile smartphones today are equipped with numerous sensors that can all help to aid in new safety enhancements for drivers on the road. For example, certain aspects of the method described herein utilize the 3-axis accelerometer and embedded microphone of a smartphone to record and analyze vehicle comfort levels, external road conditions, and various driver characteristics that are all potentially hazardous to the health of the driver, automobile, and surrounding public. Effective use of this data can educate a potentially dangerous driver on how to operate a vehicle safely and efficiently. The method can also be utilized to create numerous applications that examine many factors corresponding to drivers on the road, and with real time analysis of these factors, a driver's overall awareness can be increased to maximize safety.

The current method differs from related work in the field of sensor-aided driving with the use of a single measuring device, a mobile smartphone. All sensors are embedded and easily accessible using a suitable platform, including but not limited to the Android platform. Both comfort levels of a vehicle and road anomalies can be identified.

Using a mobile phone for monitoring and detecting driving conditions creates numerous variables that must be accounted for. Phone placement and orientation inside the car should be configured or compensated to achieve accurate measurements. Driving behaviors vary from driver to driver and performance may be exhibited unsafe to some while safe for others. The type of automobile being driven might be a factor as some cars are able to perform certain movements with ease. These movements might be safe for the driver but be viewed hazardous in the eyes the public. Constituting a comfortable ride in a vehicle is difficult as it can be different for everyone.

### BRIEF DESCRIPTION OF THE DRAWINGS

FIG. 1 shows an example representation of a smartphone and a 3-axis diagram of the accelerometer;

FIG. 2 shows a general diagram for analysis of vehicle comfort utilizing audio and vibration data obtained inside a vehicle by a mobile phone;

FIG. 3 shows the Averaged Ride Index for each of five tested vehicles calculated for each of three roads, with a lower value indicating a higher vehicle comfort;

FIG. 4 shows the averaged median relative sensory pleasantness of three road types for each of five tested vehicles, which a higher value indicating greater vehicle comfort;

FIG. 5 shows engine performance in the form of gear shift analysis of an automobile measured using the y-axis of an accelerometer of a mobile phone;

FIG. 6 shows an analysis of acceleration in the y-axis versus time for examples of (a) safe acceleration and deceleration, (b) unsafe acceleration, and (c) unsafe deceleration;

FIG. 7 shows an analysis of acceleration in the x-axis versus time for examples of lane changes performed (a) safely and (b) unsafely;

FIG. 8 shows an analysis of acceleration when moving over a road anomaly such as a pothole or bump (a) in the z-axis only and (b) in the z-axis and x-axis, which helps distinguish potholes from bumps; and

FIG. 9 shows acceleration recorded using the z-axis of the accelerometer of a mobile phone when moving over a speed bump at 7.5 mph.

### DETAILED DESCRIPTION OF PREFERRED EMBODIMENTS

Generally, the present disclosure relates to methods for detecting and analyzing driving conditions and habits using a smartphone. In particular, the present disclosure relates to mapping anomalies of a road's surface, as well as analyzing driver behavior and vehicle comfort.

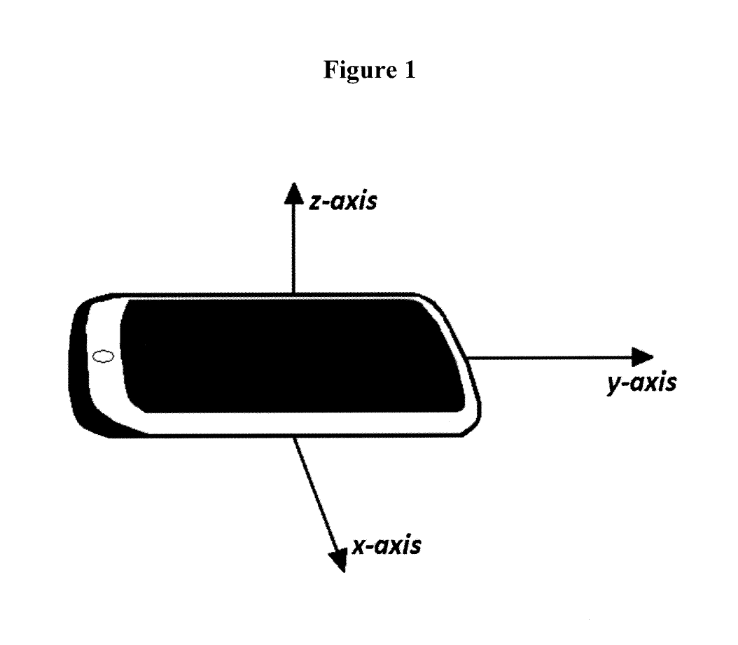

A preferred device that can be used to carry out the methods described herein includes a smartphone that is equipped with a 3-axis accelerometer. One example is an ANDROID based smartphone, the NEXUS ONE (Google Inc., Mountainview, Calif.). Phones operating similar platforms to the ANDROID platform will make it relatively easy to measure and acquire data to be analyzed thoroughly. Given its mobility and rise in popularity the past few years, a smartphone-based measuring device makes these findings unique and applicable for future implementations. The accelerometer can be a Bosch BMA150 3-axis accelerometer that is capable of detecting multiple motions triggered by a vehicle. These motions include acceleration, braking, uneven road conditions, and any degree of change in direction performed by the automobile. The accelerometer has a sensitivity range of +2 g/4 g/8 g with a max axial refresh rate of 3300 Hz. The limitations of the refresh rate and software integration yield a usable refresh rate around 25-30 Hz. Results of experimental comparison tests show the accelerometer is accurate and sensitive at 25 Hz. FIG. 1 shows an example representation of a smartphone and a 3-axis diagram of the accelerometer. Movements detected by the accelerometer may be the slightest lane change or a disturbance caused by a pothole.

To measure and analyze the changes in direction detected by the accelerometer, it must be taken into account the specific action in which these movements take place. Table 1 below refers to each axis of the accelerometer of the phone and its respective direction in which the movement may be experienced. Along with the direction is an example of what might be the cause of this sudden axial movement. If any movement is detected, it will be analyzed and expressed numerically in these directions. Only the relevant axis that is applicable for each different feature is studied, such as the y-axis signifying a sudden change in acceleration or deceleration.

TABLE 1
SIGNIFICANCE OF TRIAXIAL MEASUREMENTS

Measurements Obtained

| Axis | Direction | Typical Driving |
|---|---|---|
| x | Left/right | Turning or Lane Change |
| y | Front/rear | Acceleration or Braking |
| z | Up/down | Vibrations or Road Anomalies |

Orientation of the phone is a variable that is constantly changing with the movement of the car and may be placed arbitrarily inside the car when the driver enters. The phone's orientation should preferably remain relatively the same, with the y-axis pointing towards the front of the car and the screen up facing the ceiling. The orientation can be changed for some analysis, rotating the phone 180 degrees with front of the phone now pointing towards the back of the car. However, if the phone is not in either of these positions, a calibration technique must be performed to provide an accurate analysis of the specific movements executed by the vehicle.

Testing of the phone in various locations around the vehicle revealed that placing the phone in the floorboard of the front passenger section gave the best analysis of road conditions. Placing the phone on the front passenger seat gave the best analysis of driver comfort and driving habits. In both cases, the phone should be secured so it does not bounce. For example, the phone can be placed in its holder or case and secured with a fastener such as a hook and loop fastener, or Velcro.

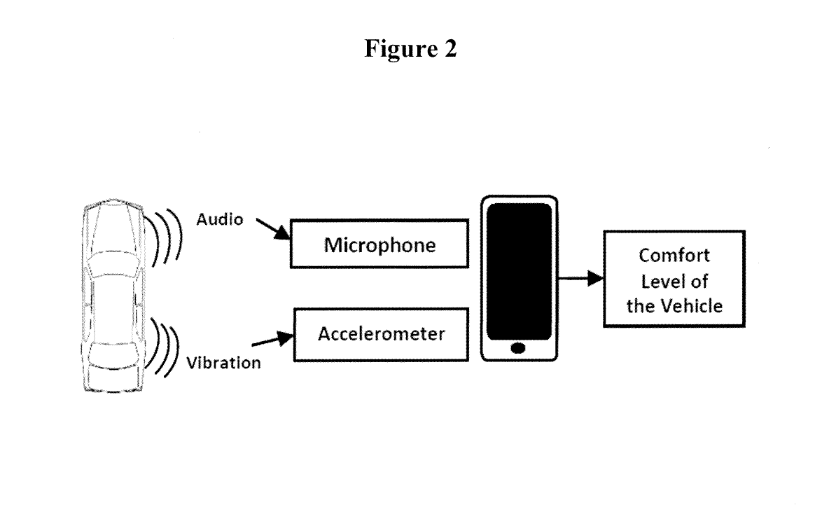

There are three independent angles to take into account when dealing with the phone's orientation: the azimuth, the pitch, and the roll. The azimuth is the direction the phone is facing or the rotation around the z-axis. The pitch shows a slant upward or downward from the direction of travel and is the rotation around the x-axis. Last is the roll which is the rotation around the y-axis. Moving the phone onto its side changes the roll value recorded by the accelerometer. Understanding two-dimensional rotation is fundamental when calculating three-dimensional rotation. Two-dimensional rotation matrices can be used to provide a generalization into three-dimensional rotation. Theoretically it is possible to correct for pitch and roll at the same time; however, more research is needed to fully compensate the phone orientation problem correctly. After a simple coordinate transformation was performed on the measured accelerometer values and analyzed with original values, a 0.5% error was seen in the z-axis. FIG. 2 represents the orientation and different locations for the phone that were used in the car.

One method relates to analyzing vehicle performance in a subject vehicle. In this method, a first step is placing a smartphone in the vehicle being analyzed. The smartphone should include a 3-axis accelerometer and an operating system platform capable of collecting data from the accelerometer relating to an x-axis, y-axis, and z-axis. In a next step, data is collected from the accelerometer relating to acceleration and deceleration in the y-axis as a function of time. The next step is identifying time periods of deceleration in the y-axis that represent a start and a finish of a gear shift. Velocity at each start of a gear shift is then calculated. Finally, using the calculated velocity at each start of a gear shift, the gear shift efficiency for the subject vehicle can be analyzed.

Another method relates to analyzing vehicle comfort. Again, a first step is placing a smartphone in the vehicle being tested. The smartphone should include a 3-axis accelerometer and an operating system platform capable of collecting data from the accelerometer relating to an x-axis, y-axis, and z-axis. The smartphone can also contain a microphone and an operating system platform capable of collecting data from the microphone relating to noise level. In a next step, data is collected from the accelerometer relating to acceleration and deceleration in the z-axis at a selected velocity, which indicates the presence and severity of any vehicle vibrations. Also, data can be collected either alone or in combination with the acceleration data relating to noise level at a selected velocity. Together or separately, the data relating to vibrations and noise level can be analyzed to determine the relative “comfort” of that vehicle.

With regard to safe driving habits, a driver's tendency to accelerate or decelerate sharply, and thus unsafely, can also be analyzed. Again, a first step is placing a smartphone in the vehicle being tested. The smartphone should include a 3-axis accelerometer and an operating system platform capable of collecting data from the accelerometer relating to an x-axis, y-axis, and z-axis. Data is then collected from the accelerometer relating to acceleration and deceleration in the y-axis as a function of time. Time periods of acceleration and deceleration in the y-axis can be identified because they will be represented as inclines or declines in the slope of the collected acceleration data as it is mapped relative to time. The relative safety of the driver's acceleration and deceleration habits can then be analyzed by reviewing the relative “steepness” of the inclines and declines. Steeper slopes indicate unsafe driving practices.

Safe stopping distance at a particular acceleration can also be calculated. Using the same method described above, time periods of acceleration in the y-axis can be identified, with a start and a stop to the acceleration being determinable from the collected data. The acceleration calculated at the stop of acceleration can then be used to calculate the safe stopping distance. This can be done either by performing a single integration of the data to give velocity, allowing a further calculation of time required to stop and therefore distance, or by performing a double integration of the data to give stopping distance.

Safe driving practices while changing lanes can also be determined. In this method, a smartphone containing a 3-axis accelerometer is again placed in the subject vehicle Then, data is collected relating to acceleration and deceleration in the x-axis as a function of time. Again, inclines and declines in the collected data as it relates to time represent periods of acceleration and deceleration during lane changes. The safety of the lane changes can be determined by analyzing the “steepness” of the slopes. Steep slopes indicate excessive acceleration and deceleration during lane changes, which is indicative of unsafe driving practices.

Road conditions, or the presence or absence of road surface irregularities, can also be analyzed. In this method, a smartphone containing a 3-axis accelerometer is again placed in the subject vehicle Then, data is collected relating to acceleration and deceleration in the z-axis as a function of time. Noticeable periods of acceleration and deceleration in the z-axis are indicative of a road surface irregularity, such as a pothole or speed bump. Analysis of the overall change in z-axis acceleration or deceleration allows the severity of the irregularity to be determined. Further, the height of the road surface irregularity can be calculated by performing two integrations of the data collected from the accelerometer to give distance. In further applications, simultaneous collection of GPS coordinates can be accomplished and related to the data collected by the accelerometer. This would allow for the production of a map showing particular areas located using GPS coordinates that have particularly bad road surface irregularities.

### Example 1

### Analyzing Vehicle Comfort

For a driver to feel completely safe, he or she must have total control over the vehicle being operated. This factors into the idea of how the driver feels and reacts while on the road. It is essential to secure this relationship for a driver to be fully confident in their abilities on the road. Different types of automobiles such trucks or cars perform differently and offer many types of unique features that can be categorized as personal comforts: rear camera support, side airbags, sound dampening technology, and low engine vibration levels. Identifying this comfort level is an initial step to buying a car and should be considered as a safety parameter for drivers. The comfort of a vehicle directly reflects the health of the passenger and the driver.

In order to assess the comfort of a vehicle while driving, the accelerometer and microphone in the smartphone are used to quantify vehicle vibrations and noise levels. FIG. 2 illustrates a general system diagram for determining the comfort level of a vehicle. During each experiment, the accelerometer and microphone were set to record data simultaneously. The x, y, and z axes of the accelerometer were used to find the total vibrations in each direction present in the passenger seat while the microphone recorded the interior audio levels of the vehicle.

### Noise and Vibration Levels

It can be distinguished that the most comfortable car would be that exhibiting low noise and subtle vibration levels. Table 2 below shows the vibration levels for each of three tested cars at different speeds. It also identifies the most comfortable car based on the difference between minimum and maximum vibration levels. The smallest difference would describe the smoothest ride experienced by the driver and determine the highest comfort level. The data demonstrates that with a superior engine, Car 3 results in the best performance while stationary, but was the most uncomfortable at a constant speed of 30 mph. However, Car 1, with the smallest engine, performs opposite of Car 3 resulting with the highest comfort level at 30 mph, and the worst results when immobile.

TABLE 2
Automobiles Used in Determining Comfort Levels

| Code | Car Type | Manufacture | Model | Year | Engine Capacity |
|---|---|---|---|---|---|
| Car 1 | Sedan | Nissan | Versa | 2007 | 1800 cc |
| Car 2 | Sedan | Toyota | Camry | 1999 | 2400 cc |
| Car 3 | Coupe | Honda | Acura | 1997 | 3000 cc |

TABLE 3
MIN AND MAX VIBRATIONS LEVELS FOR DIFFERENT
AUTOMOBILES

| | | Accelerometer | | |
|---|---|---|---|---|
| | Accelerometer | Max | Speed | Highest |
| Car | Min (m/s²) | (m/s²) | (mph) | Comfort |
| 1 | 9.70 | 10.35 | 0 | |
| 2 | 9.50 | 10.70 | 0 | |
| 3 | 9.50 | 10.00 | 0 | ✓ |
| 1 | 9.00 | 10.40 | 30 | ✓ |
| 2 | 8.90 | 10.60 | 30 | |
| 3 | 8.00 | 11.50 | 30 | |

TABLE 4
MAXIMUM NOISE LEVEL RECORDED FOR DIFFERENT
AUTOMOBILES

| | Noise Level | Speed | Highest |
|---|---|---|---|
| Car | (10⁻³) | (mph) | Comfort |
| 1 | −46 | 0 | |
| 2 | −52 | 0 | |
| 3 | −53 | 0 | ✓ |
| 1 | −32 | 30 | ✓ |
| 2 | −29 | 30 | |
| 3 | −29 | 30 | |

Table 4, which shows the peak noise levels as an intensity value present inside each of the three cars, paralleled the comfort results of Table 3. To accomplish these measurements, a 16 bit sound file with a maximum possible sampling value and reference point at 32767 was used. For this 16 bit sound file, the noise level ranged from a maximum 0 dB to a minimum −90 dB. The noise and vibration levels shared a positive relationship as Car 3 resulted in the lowest noise when stationary and Car 1 had the lowest noise levels at 30 mph. When measuring the back seat, conflicting results were apparent with low noise and medium vibrations depending on the vehicle being measured. Since the driver is in control of the car, the front seat was stressed, signifying its importance in these analyses. These measurements not only secure the driver with a comfortable experience on the road, but also decrease safety concerns that may have existed previously. It can be insinuated that a good comfort level is necessary to achieve maximum awareness regarding safety by increasing recognition of vehicle conditions and the surrounding environment.

### Vibrational Comfort

Identifying the comfort of a vehicle can be different when experiencing different types of roads. Performance of each vehicle depends greatly on the type of the road as well as the performance of the driver. To find the appropriate comfort, three types of roads were selected to test each vehicle: 1) Residential 2) Business (Urban) 3) Highway (Interstate). The usage of these roads is based on the area, thus determining the quality of the road while the frequency of the maintenance also differs. The driving speed is also another factor in measuring the comfort level of a vehicle. Therefore, the posted speed limit of the particular road was selected as the traveling speed to obtain readings. To minimize the speed variation, the cruise control was used whenever possible. In short, five vehicles were driven on each road type using its posted speed limit and the right lane was used when encountering a divided highway with two or more lanes. Table 5 below shows the five different automobiles that were used to acquire comfort measurements. To obtain a variety of measurements, vehicles used vary in both type and year. Table 6 below shows the road types that were used in the vibrational and acoustical comfort experiments along with the speed limit and measurement duration.

TABLE 5
Automobiles Used in Determining Comfort Levels

| | | Man- | | Vehicle | |
|---|---|---|---|---|---|
| Code | Year | ufacturer | Model | Type | Engine |
| Truck 1 | 1992 | Chevrolet | S-10 | Single Cab | 4.3 L V6 |
| Car 1 | 1997 | Honda | CL3 | Sedan | 3.0 L V6 |
| Van 1 | 2000 | Toyota | Sienna | Coupe | 3.0 L V6 |
| Car 2 | 2007 | Toyota | Yaris | Sedan | 1.3 L 4-cylinder |
| Car 3 | 2007 | Volvo | S40 | Sedan | 2.4 L 5-cylinder |

TABLE 6
Road Types Used In Assessing Comfort Of Vehicle

| Road Type | Speed Limit (mph) | Duration (s) |
|---|---|---|
| Residential | 30 | 60 |
| Business | 35 | 60 |
| Highway | 60 | 60 |

The International Organization for Standardization (ISO) standards 2631-1 were incorporated for determining total ride comfort. ISO 2631-1 describes how human comfort can be calculated pertaining to location and axial vibrations experienced inside the vehicle and defines a comfort scale based on the Vibration Dose Value (VDV). VDV uses frequency weights on each axis of vibrational data, for a given frequency range of 0.5-80 Hz and is defined using the weighted axial acceleration values (αᵢ) during a time duration (T) with units of m/s. A Ride Index (RI) value is then calculated using the VDV axis measurement. The equations for these calculations are shown below. Given the sensor limitations and studies showing high comfort correlation between 2-20 Hz, a frequency range of 2-12.5 Hz was used. Each road measurement had a time duration of 60 seconds.

$$VDV = {[ {\int }_{t = 0}^{t = T} {a}_{i}^{4} ( t ) d t ]}^{\frac{1}{4}}$$

$$RI = {( {\sum }_{t = 1}^{3} {VDV}_{i}^{4} )}^{\frac{1}{4}}$$

Using the ISO 2631-1 Vibrational Dose Value (VDV) methodology, a Ride Index was obtained for the five vehicles of Table 5 between the road types of Table 6. Performance of each vehicle depended highly on the type of road driven and also driver behavior. Since the Ride Index (RI), measured in m/s, depends on VDV axial measurements, the dependencies for each axis are noted. The y-axis was greatly affected by driver performance such as acceleration and braking. The z-axis was dependent on the condition of the road such as potholes and bumps, and the x-axis reflects results based on both the driver and the road. Table 7 below shows the results obtained during the vibrational ride comfort analysis. Each value is a Ride Index formulated from the vibrations experienced in the x, y, and z axes of the passenger seat using a mobile phone accelerometer. A lower Ride Index value illustrates a greater vehicle comfort. The values were averaged from multiple runs from each road at the same time of day and distance traveled.

TABLE 7
Vibrational Ride Index Obtained in Vehicle Comfort Analysis

| | Road Type and Ride Index | | |
|---|---|---|---|
| | Residential | Business | Highway |
| Vehicle | (30 mph) | (35 mph) | (65 mph) |
| Truck 1 | 6.0293 | 5.4484 | 5.2834 |
| Car 1 | 6.1492 | 5.5629 | 5.0808 |
| Van 1 | 5.0851 | 4.6929 | 4.0218 |
| Car 2 | 3.2230 | 2.7210 | 2.2232 |
| Car 3 | 8.3149 | 7.3665 | 8.1856 |

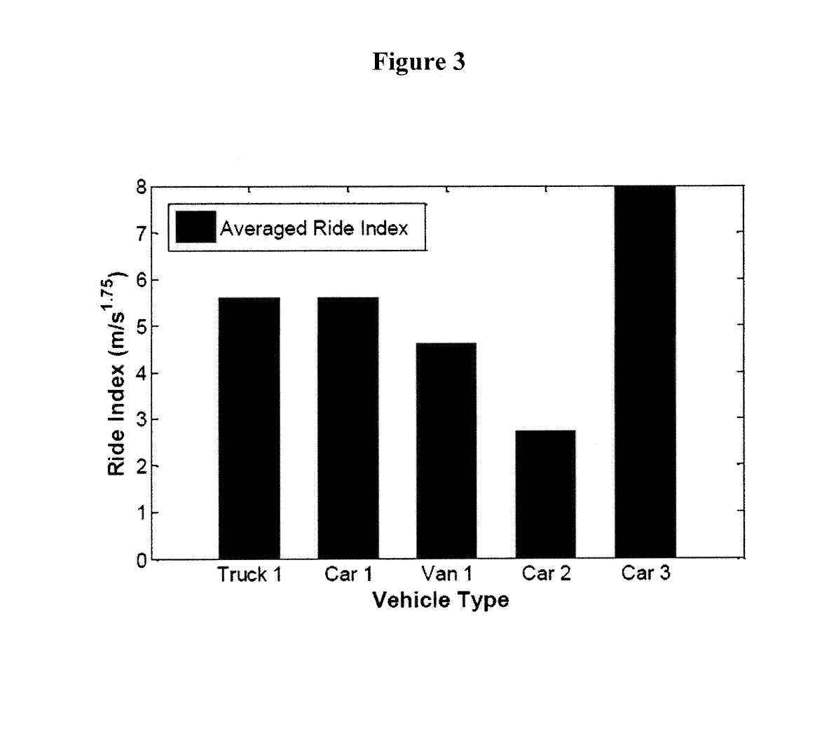

From the data presented in Table 7 above, it can be concluded that Car 2, the Toyota Yaris, experienced the greatest comfort pertaining to seat vibration originating from a combination of the driver and the road. Each road has a designated classification which correlates with the speed limit and also the road quality. This road quality can directly reflect on the Ride Index as some vehicles perform better on certain types of roads which might include potholes and rough roads. In short, vehicles perform differently on different roads. These different rankings can be seen in Table 7 as Truck 1 is ranked third on the Residential road but fourth on the Highway. In contrast, the Ride Index can directly reflect the condition of the road but is greatly dependent on the speed. Since drivers usually encounter each road type during a driving duration, the ride index is averaged for each vehicle over the three road types to gain an idea of the vehicle's overall performance or comfort level. This can be seen in FIG. 3 with Car 2 having the greatest average comfort on the road.

### Noise Comfort

For audio analysis, vehicle sound quality metrics were used to define interior noise comfort as a function of Sensory Pleasantness. Sensory Pleasantness (P) is defined using multiple sound metrics: Roughness (R), Sharpness (S), Tonality (T) and Loudness (N). All these components are represented in the equation below to formulate a quantitative value which can be to determine noise comfort. An arbitrary reference measurement was taken in a vehicle to portray the ideal audio comfort scenario as a comparison to the other five vehicles. These values are calculated and used in the equation below as P₀, R₀, S₀, T₀, and N₀.

$$\frac{P}{{P}_{0}} = {e}^{- 0.7 \frac{R}{{R}_{0}}} {e}^{- 1.08 \frac{S}{{S}_{0}}} ( 1.24 - {e}^{- 2.43 \frac{T}{{T}_{0}}} ) {e}^{- {( 0.023 \frac{N}{{N}_{0}} )}^{2}}$$

Similar techniques on measuring noise comfort of a vehicle have been done by using sound quality measurements for example, loudness, sharpness, and fluctuation strength (Ford October 2005). Similar techniques were also performed with the use of sound metrics for the basis of acoustical comfort index with the addition of roughness also defined on individual road types (Nor et al. 2008). By a quantitative measurement from psychoacoustics which is formulated by multiple sound metrics, a noise comfort comparison was created. Audio measurements were recorded simultaneously with vibrations in 60 second durations. Results are shown in Table 8 below.

TABLE 8
Sensory Pleasantness Obtained in Audio Comfort Analysis

| | Road Type and Normalized Sensory | | |
|---|---|---|---|
| | Pleasantness | | |
| | Residential | Business | Highway |
| Vehicle | (30 mph) | (35 mph) | (65 mph) |
| Truck 1 | 1 | 1 | 1 |
| Car 1 | 0.0506 | 0.1323 | 0.1495 |
| Van 1 | 0.2258 | 0.2125 | 0.5318 |
| Car 2 | 0.1096 | 0.0702 | 0.1427 |
| Car 3 | 0.0087 | 0.0105 | 0.1117 |

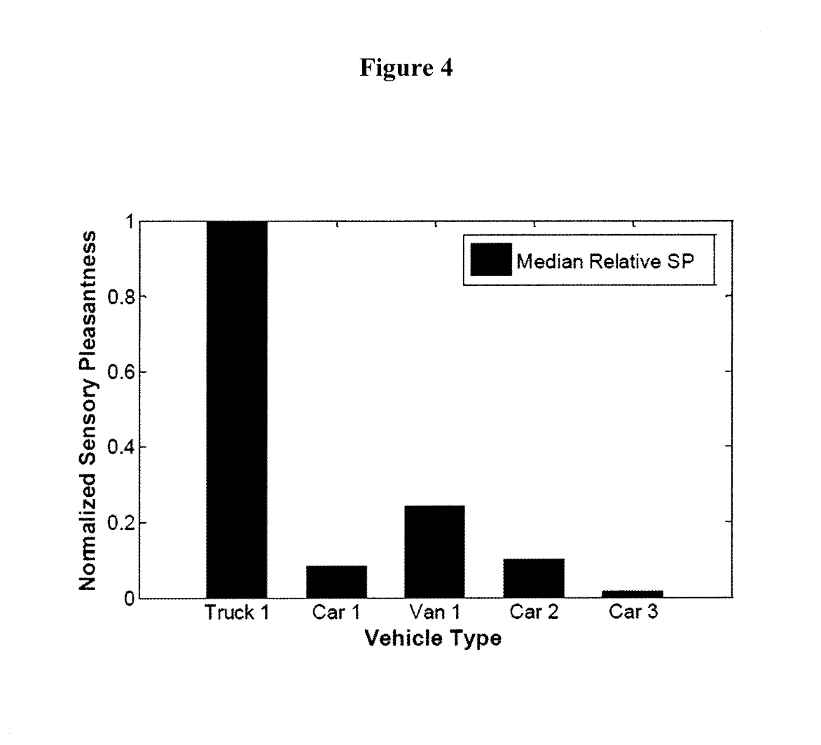

The audio comfort analysis is was performed simultaneously as the vibrational comfort analysis. Multiple trials for each road were performed and then averaged together to determine the overall sensory pleasantness value shown in FIG. 4. The sound quality metrics used which formulate a comparable noise comfort are median values of loudness (L), sharpness (S), and roughness (R). Hence, the final sensory pleasantness value obtained is the median relative sensory pleasantness (MRSP). Since tonality has little effect on sensory pleasantness and it is purely subjective, it is provided with a constant. Table 8 above represents the normalized relative median sensory pleasantness of each road type.

The values are normalized against the highest sensory pleasantness value for each road. It can be seen that the Chevrolet S-10 has the highest MRSP value in each trial for each road. A higher sensory pleasantness value designates a more comfortable audio related experience. Despite its year, the truck provides a different vehicle build when comparing to the other vehicles. The truck is a single cab vehicle giving a lower sound pressure level. The tires are larger along with suspension height creating a greater distance from cabin position to the physical road. These characteristics all factor in to provide a greater acoustical comfort for the driver. FIG. 4 illustrates the normalized sensory pleasantness that was averaged for each vehicle type Truck 1 greatly outperforms the other vehicles in this area.

### Example 2

### Analyzing Vehicle Performance

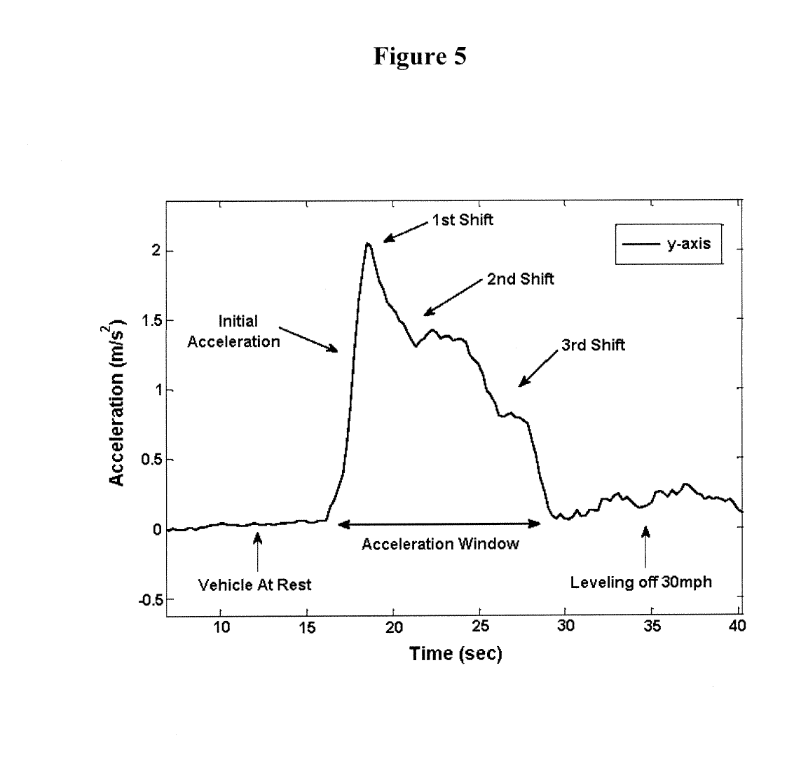

Knowing that a car is performing efficiently is a concern for many drivers on the road. Engine problems can arise at any time even while accelerating in high speed traffic. Slipping in and out of gears can happen frequently with older transmissions and can be a potential risk while driving down the highway. Using a mobile smartphone, it is possible to recognize these gear shifts that take place in the engine. Sequentially shifting around 2500 RPM is essential in obtaining an efficient fuel economy for manual transmissions. Recognizing gear slippage in automatic transmissions can be an early warning of low transmission fluid, worn clutch discs or a faulty shift solenoid which are all essential components responsible for transporting you safely to your next destination. FIG. 5 shows a vehicle, in this case Truck 1, starting from rest and accelerating to approximately 30 mph before leveling off. FIG. 5 was converted to velocity by integrating the curve using the trapezoidal method. With this the speeds can be calculated at each shift and referenced at any given time. Further integration reveals the total displacement. Table 9 below shows each gear shift at its relative time, also illustrated in FIG. 5. The actual speed at the time of the study was recorded from the car's dashboard and is compared with the speed derived using the trapezoidal method. Percent error is also shown which reveals the accelerometer to be very accurate with increasing speeds. A sequential shift pattern is necessary for a vehicle to operate efficiently and maintain peak performance. Identifying gear shifts that are less apparent, as seen in higher quality automobiles such as luxury cars, indicates greater longitudinal comfort, which was discussed in Example 1.

TABLE 9
Gear Shifts Related to Velocity

| | Time | Dashboard | Speed from | |
|---|---|---|---|---|
| | Occurred | Speed | Integration | Percent |
| Gear Shift | (s) | (mph) | (mph) | Error |
| 1 | 11.20 | 14 | 13.42 | 4.14% |
| 2 | 14.51 | 20 | 20.13 | 0.64% |
| 3 | 17.55 | 31 | 31.30 | 0.96% |

### Example 3

### Analyzing Driving Patterns

Knowing that a driver is driving correctly and safely is beneficial to that driver's life and to the lives of drivers around him or her. The way a vehicle is maneuvered on the road can influence how other drivers react as they habitually follow other drivers' movements to potentially avoid an unforeseen road hazard.

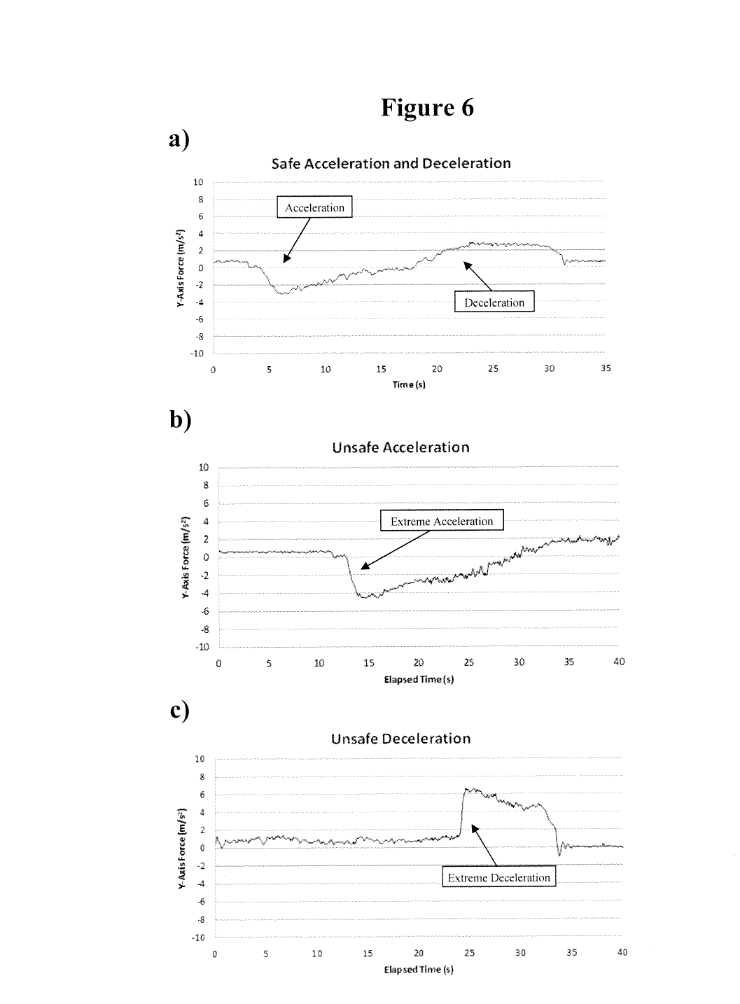

The x-axis and y-axis data from the accelerometer were used to measure the driver's direct control of the vehicle as they steered, accelerated and applied the brakes. The phone was oriented with the front of the phone facing the rear of the car, rotating it 180 degrees from the previous orientation placement. With the phone in the front passenger seat, driving behaviors of acceleration and deceleration were recorded in safe and extreme conditions shown in FIG. 6.

A safe acceleration and deceleration are shown in FIG. 6a as a gradual decline and incline in the acceleration measurements respectively. As seen in the graph, safe acceleration and deceleration never reaches more than ±0.3 G (g-force). A slope and maximum g-force threshold were set and compared with more extreme scenarios. FIGS. 6b and 6c illustrate a situation in which the driver quickly accelerates and decelerates, respectively. Both are shown as a steep incline or decline in the acceleration (y-axis), and this is clearly noticeable for both situations. By using this data, it is easy to see the difference between safe and unsafe deceleration.

Because accurate speed and distance calculations can be obtained for short distances, the braking distance of a vehicle can also be measured. Table 9, above, illustrates the percent error at certain time intervals during a gear shift experiment. Since speed calculations are not as accurate for greater distances, the GPS of the phone is utilized for greater speed and distance calculations. A starting point and stopping point were marked in which the brakes were applied and the car to stopped respectively. The speed was taken from the GPS values at the moment before deceleration, the time at which the driver applies the brake, and the time at which the driver stops completely. Each point is easily distinguished in FIG. 6a and can be used to compare with the total time needed to stop. The distance was then easily calculated from these GPS waypoints. In some cases, the driver was unable to stop the car before the stopping line, producing an excessive force onto the brakes. In these scenarios, an unsafe deceleration could easily be identified like that in FIG. 6c. In trials, the total braking distance acquired through GPS displayed great accuracy and potential for determining safe braking techniques.

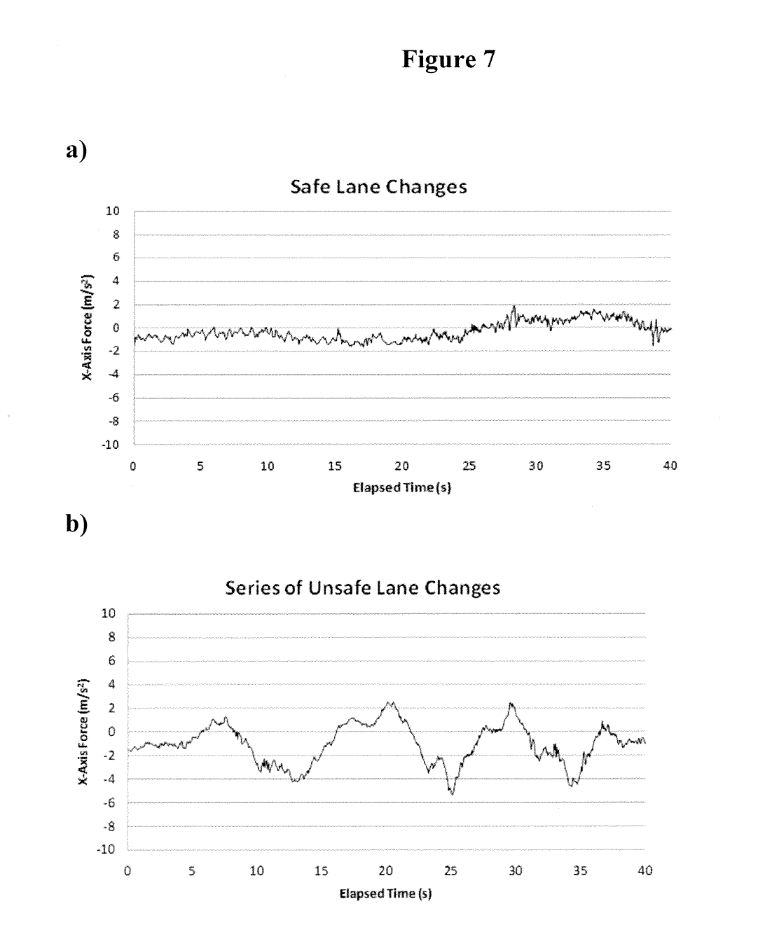

To recognize lane changes with the accelerometer, the data recorded by the x-axis was analyzed. This helps to distinguish a driver's ability to safely change lanes. Using the previous phone orientation and placement from the acceleration and deceleration measurements above, it is possible to recognize lateral movements created by an automobile. FIG. 7 illustrates safe and unsafe lane changes experienced by a driver on the road. A left lane change is portrayed by a decrease in acceleration while a right lane change is shown as an increase. These opposing patterns can be viewed in FIG. 7a as the driver completes two safe lane changes, left and right, using proper technique. Improper technique can be seen in FIG. 7b as a driver generates four unsafe lane changes created by swerving the car into the left lane and back again into the right. Using this data, the ability to count the number of lane changes that occur and at what time is provided, but also the possibility to classify safe and unsafe lane changes. These unsafe lane changes produce a g-force well over ±0.5 G. This can be set as a threshold to analyze future unsafe lane changes such as unintended lane deviations and the act of swerving in and out of high speed traffic that endangers the lives of everyone on the road.

### Example 4

### Analyzing Road Conditions

Poor road conditions can result in traffic slowdowns and re-pavement construction efforts that cause grueling traffic congestion which consequently lead to more fuel consumption and increased traveling time. A bad road can also increase the chance of an accident. Road conditions can be analyzed using a motion sensor such as an accelerometer that is capable of detecting subtle and extreme vibrations experienced inside the vehicle while it is in motion. These vibrations can be in the form of jerks or bumps created by a rugged surface that is present on many of the roads seen today. Speed bumps and potholes are two nuisances that plague drivers on the road every day. Using a smartphone, these annoyances can be analyzed using the z-axis and x-axis of the accelerometer. When a car experiences a bump, the car ascends onto the bump resulting in a sustained rise or spike in the value of the z-axis. This also sometimes creates a subsequent increase in the x-axis. At high speeds, the spike in the value of z-axis is very prominent. However, for low speeds, this rise is not as obvious, but still leaves an apparent impact. To detect bumps at low speeds, the x-axis and a dynamic threshold based on speed are used to compensate. If the difference between two consecutive acceleration values of the z-axis exceeds the threshold, as well as an x-axis threshold, a bump can be assumed.

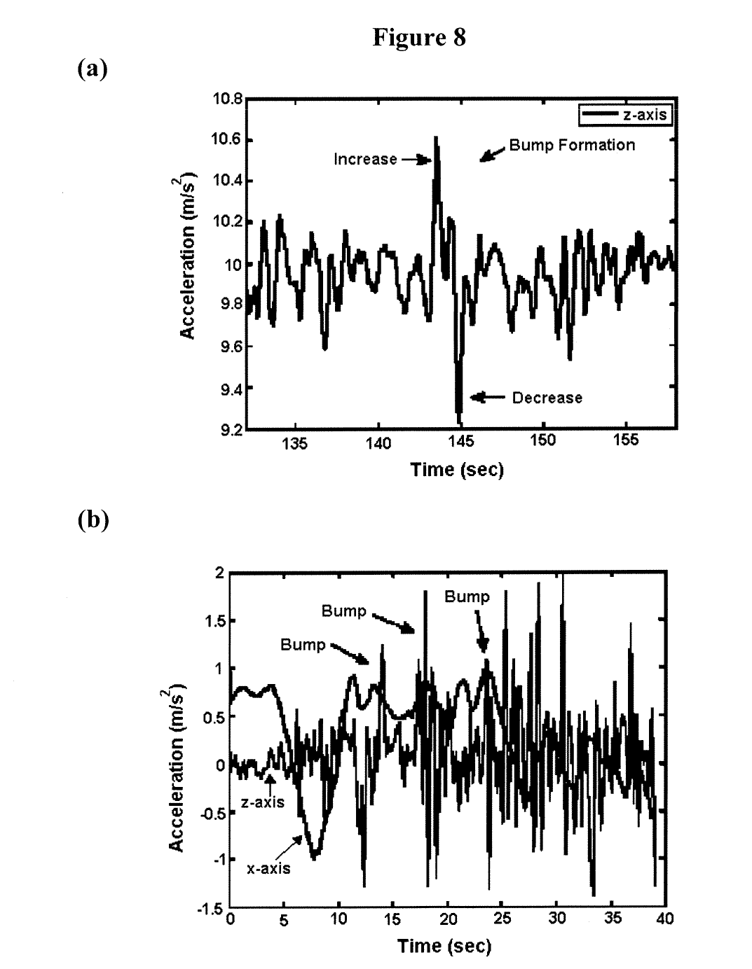

Differentiating a pothole from a bump can sometimes be difficult using only a z-axis threshold but is easily differentiated using this method. The method is visually illustrated in FIG. 8. FIG. 8 shows bumps recorded using the accelerometer of a mobile phone. In FIG. 8a the bump is shown with an increase in the z-axis followed by a decrease. FIG. 8b illustrates a secondary process in classifying a bump with incorporates the x-axis. An increase in the x-axis helps distinguish a pothole from a bump.

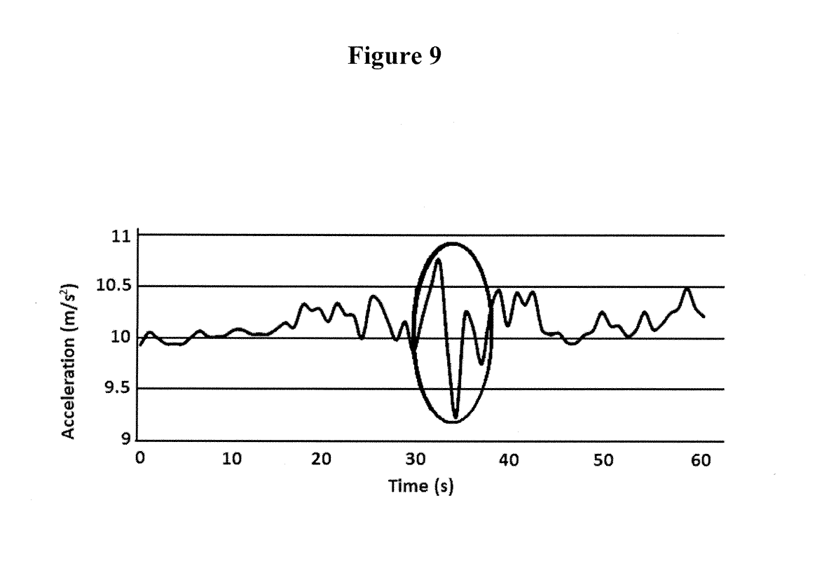

The height of the bump can be calculated by using simple physics equations dealing with acceleration, time, and displacement. This is shown in Table 10 below along with related speed and accelerometer values. Though this height might not be an exact measurement of the speed bump, these low values can be normalized with the actual size of the bump to find a value or multiple that can be factored in. This multiple will be different for every speed and once known can provide a better estimate on the exact height of the bump. At 20 mph, this technique is very accurately shown in Table 10 with a displacement of 6.06 cm and a measured speed bump height of 6 cm. FIG. 9 illustrates a recording of the accelerometer traveling over a bump at a speed of 7.5 mph, as shown in Table 10. Though a motion is clearly visible in FIG. 9, at low speeds the height calculations became unreliable as the car experienced a more comfortable smooth movement rather than the jerk seen at higher speeds. The results were heavily influenced by how the vehicle approached the bump and at what velocity. Since this presents magnitudes with different spike characteristics at various speeds, a threshold needs to be set based on what speed the vehicle approaches the bump to accurately assess the height of the speed bump or displacement the car experiences. This process can also be utilized to calculate the depth of potholes to help further in identifying uneven roads.

TABLE 10
DISPLACEMENT OF SPEED BUMP RELATED TO SPEED

| | Accelerometer Min | Accelerometer Max | Displacement |
|---|---|---|---|
| Speed (mph) | (m/s²) | (m/s²) | in z-axis (cm) |
| 7.5 | 9.3 | 10.81 | 1.5 |
| 10 | 7.09 | 11.49 | 4.3 |
| 15 | 6.93 | 12.37 | 5.4 |
| 20 | 9.38 | 12.47 | 6.06 |

In addition to the accelerometer readings, GPS coordinates were recorded at the time of the pothole. All of the accelerometer z-axis values were taken for a single GPS value. This value was denoted as a segment of a particular area. In case of multiple accelerometer values, interpolation was used and that value was assigned to the particular segment. Each segment received a corresponding value that designated the degree of the road: smooth, uneven or rough. A color code technique was used and assigned to certain interpolated values for segments. A map of road conditions can be derived from measurements taken on an uneven road. From this the conditions of the road can be visualized before drivers have to unwittingly experience them. For example, red could illustrate a pothole, purple could designate a bump, blue could designate an uneven road, orange could signify a rough road, and green could represent a smooth surface with ideal driving conditions.

### Example 5

### Applications

Vehicle users don't typically know much about the technical aspects of an automobile, so they are not aware of any faults that may occur in the vehicle. Some might obtain a basic knowledge of these faults but generally fail to identify these potentially hazardous problems. Most vehicle owners consequently end up with severe damage to their vehicle or are involved in fatal accidents because these once minor problems are not solved in time. Diagnosing engine and vehicle noises using a combination of the accelerometer and microphone can help to repair malfunctioning parts before it is too late, avoiding the expensive replacement costs for new parts. Noises originating from belts, brakes, tires, and radiator fans can all be distinguished and categorized as a potential hazard to the health of your car. Preventing potential vehicle hazards before they happen can ultimately save lives. For example, before a blowout occurs, a characteristic “flapping” noise can be heard coming from the fatigued tire. Smartphone-based detection and analyses of these noises, categorizing them as risks, and letting the driver know to safely pull over out of high speed traffic before the tire degrades further, are all applications of the current method.

The passenger and driver are the two most important entities that manufacturers focus their attention on when installing safety measures. However, some safety concerns when riding in a car deal with individual human bodies and are different for everyone. Motion sickness is one of the most common automobile related problems afflicting nearly 80% of the public. It is defined as an uncomfortable dizziness experienced by people when their sense of balance or equilibrium is disturbed due to the constant movement created by the car. The dizziness is followed by nausea and ultimately vomiting, providing a most uncomfortable riding experience for everyone involved. The current method would allow for analysis of vehicle vibrations and other movement and additional studies relating to motion sickness. Finding a certain maximum tolerability threshold for this health condition to worn passengers of the potential risk could be an additional application.

With the majority of the public using mobile phones today, a collective contribution of road condition analyses provides extreme benefits that are not limited to just a safe driving experience. The benefits that arise from analyzing road conditions not only will help drivers and their cars, but also the community as a whole by providing a better living environment. City governments can be notified in real time with exact locations of these horrid roads that obstruct the even flow of traffic. Road noise, surface degradation and large traffic clusters can all be reduced creating a lessened chance of a potentially harmful accident to occur. With everyone contributing to achieve this goal, these troublesome potholes can, hopefully, become a thing of the past.

Many risks arise on the road during the time needed to reach a destination. These risks include detrimental road conditions, problematic vehicle performance, and drivers operating their vehicle in a dangerous manner. All these risks have the capability to harm everyone on the road who is in close proximity. By informing other drivers on the road of these risks when they arise, future accidents can be prevented from occurring. Acceleration, braking and changing lanes can all be performed in a dangerous manner. Detecting each driver's harmful behavior and transmitting it to surrounding drivers can provide a collective awareness that has the potential to create the safest driving experience possible. If each driver could communicate with the driver behind them and provide them with information regarding brake intensity, tell the car parallel to them that they were entering their lane, and even create a “blackbox” like feature that can store all the data before an accident, a revolutionary driving experience can be created that greatly reduces the chance of an accident from ever taking place. This type of road analysis also has the potential to contribute to the future application of automated driving.

### REFERENCES CITED

The following documents and publications are hereby incorporated by reference.

### Other Publications

“Ford Motor Company Develops and Deploys
Jiangpeng Dai; Jin Term; Xiaole Bai; Zhaohui Shen; Dong Xuan; “Mobile phone based drunk driving detection,” Pervasive Computing Technologies for Healthcare (Pervasive Health), 2010 4th International Conference on, pp. 1-8, 22-25 Mar. 2010.
J. Eriksson. L. Girod, B. Hull, R. Newton, S. Madden, and H. Balakrishnan. The Pothole Patrol: Using a Mobile Sensor Network for Road Surface Monitoring. In MobiSys, 2008.
Intel Labs: Smart Car. Research at Intel Day 2010, Mountain View, Calif., Jun. 30, 2010,
P. Mohan, V. N. Padmanabhan, and R. Ramjee, Nericell: Rich Monitoring of Road and Traffic Conditions using Mobile Smartphones, In Proc. of ACM SenSys '08, Raleigh, N.C., USA, November 2008.

What is claimed is:

1. A method for analyzing vehicle performance in a subject vehicle, comprising:
placing a smartphone in the subject vehicle, wherein the smartphone includes a 3-axis accelerometer and an operating system platform capable of collecting data from the accelerometer relating to an x-axis, y-axis, and z-axis;
collecting data from the accelerometer relating to acceleration and deceleration in the y-axis as a function of time;
identifying time periods of deceleration in the y-axis that represent a start and a finish of a gear shift;
calculating velocity at each start of a gear shift; and
using the calculated velocity at each start of a gear shift to analyze gear shift efficiency for the subject vehicle.

2. The method of claim 2, further comprising the step of wirelessly transmitting the data collected from the accelerometer relating to acceleration and deceleration in the y-axis as a function of time to a central server for further analysis of the data.

3. A method for analyzing vehicle comfort in a subject vehicle, comprising:
placing a smartphone in the subject vehicle, wherein the smartphone includes a 3-axis accelerometer and an operating system platform capable of collecting data from the accelerometer relating to an x-axis, y-axis, and z-axis;
collecting data from the accelerometer relating to acceleration and deceleration in the z-axis to indicate the presence and severity of vehicle vibration at a selected velocity; and
determining the relative level of vehicle comfort by analyzing the presence and severity of vehicle vibration based on z-axis acceleration.

4. The method of claim 3, further comprising the step of wirelessly transmitting the data collected from the accelerometer relating to acceleration and deceleration in the z-axis as a function of time to a central server for further analysis of the data.

5. A method for analyzing vehicle comfort in a subject vehicle, comprising:
placing a smartphone in the subject vehicle, wherein the smartphone includes a microphone and an operating system platform capable of collecting data from the microphone relating to noise level;
collecting data from the microphone relating to noise level while driving to indicate the presence and severity of vehicle vibration at a selected velocity; and
determining the relative level of vehicle comfort by analyzing the presence and severity of vehicle vibration based on noise level.

6. The method of claim 5, further comprising the step of wirelessly transmitting the data collected from the microphone relating noise level to a central server for further analysis of the data.

7. A method for analyzing vehicle comfort in a subject vehicle, comprising:
placing a smartphone in the subject vehicle, wherein the smartphone includes a 3-axis accelerometer, a microphone, and an operating system platform capable of collecting data from the accelerometer relating to an x-axis, y-axis, and z-axis and capable of collecting data from the microphone relating to noise level;
collecting data from the accelerometer relating to acceleration and deceleration in the z-axis to indicate the presence and severity of vehicle vibration at a selected velocity;
collecting data from the microphone relating to noise level while driving to indicate the presence and severity of vehicle vibration at the selected velocity; and
determining the relative level of vehicle comfort by analyzing the presence and severity of vehicle vibration based on z-axis acceleration and noise level.

8. The method of claim 7, further comprising the step of wirelessly transmitting the data collected from the microphone relating noise level to a central server for further analysis of the data.

9. A method for analyzing a driver's tendencies to safely or unsafely accelerate or decelerate, comprising:
placing a smartphone in the subject vehicle, wherein the smartphone includes a 3-axis accelerometer and an operating system platform capable of collecting data from the accelerometer relating to an x-axis, y-axis, and z-axis;
collecting data from the accelerometer relating to acceleration and deceleration in the y-axis as a function of time;
identifying time periods of acceleration and deceleration in the y-axis, wherein the time periods of acceleration and deceleration are represented by inclines and declines having a slope in the collected data as it is related to time; and
determining the relative safety of the driver's acceleration or deceleration by analyzing the slope of the inclines and declines, wherein steep slopes indicate a lack of safety and gradual slopes indicate safety.

10. The method of claim 7, further comprising the step of wirelessly transmitting the data collected from the accelerometer relating to acceleration and deceleration in the y-axis to a central server for further analysis of the data.

11. A method for determining a safe stopping distance for a subject vehicle traveling at a rate of speed, comprising:
placing a smartphone in the subject vehicle wherein the smartphone includes a 3-axis accelerometer and an operating system platform capable of collecting data from the accelerometer relating to an x-axis, y-axis, and z-axis;
collecting data from the accelerometer relating to acceleration in the y-axis as a function of time;
identifying time periods of acceleration in the y-axis that represent a start and a stop of acceleration; and
calculating the safe stopping distance at a stop of acceleration using the data collected relating to acceleration.

12. The method of claim 11, wherein the safe stopping distance is calculated by calculating the velocity at the stop of acceleration using a single integration of the collected data.

13. The method of claim 11, wherein the safe stopping distance is calculated by calculating the distance at the stop of acceleration using two integrations of the collected data.

14. The method of claim 11, further comprising the step of wirelessly transmitting the data collected from the accelerometer relating to acceleration in the y-axis to a central server for further analysis of the data.

15. A method for analyzing a driver's tendencies to safely or unsafely change lanes, comprising:
placing a smartphone in the subject vehicle, wherein the smartphone includes a 3-axis accelerometer and an operating system platform capable of collecting data from the accelerometer relating to an x-axis, y-axis, and z-axis;
collecting data from the accelerometer relating to acceleration and deceleration in the x-axis as a function of time;
identifying time periods of acceleration and deceleration in the x-axis, wherein the time periods of acceleration and deceleration are represented by inclines and declines having a slope in the collected data as it is related to time; and
determining the relative safety of the driver's lane changes by analyzing the slope of the inclines and declines, wherein steep slopes indicate a lack of safety and gradual slopes indicate safety.

16. The method of claim 15, further comprising the step of wirelessly transmitting the data collected from the accelerometer relating to acceleration in the x-axis to a central server for further analysis of the data.

17. A method for analyzing road conditions, comprising:
placing a smartphone in a subject vehicle, wherein the smartphone includes a 3-axis accelerometer and an operating system platform capable of collecting data from the accelerometer relating to an x-axis, y-axis, and z-axis;
collecting data from the accelerometer relating to acceleration and deceleration in the z-axis to identify the presence and severity of road surface irregularities at a selected velocity and as a function of time; and
determining the relative quality of road conditions by analyzing the presence and severity of road surface irregularities based on z-axis acceleration.

18. The method of claim 17, further comprising the step of calculating the height of the road surface irregularities by performing two integrations of the data collected from the accelerometer relating to acceleration and deceleration in the z-axis.

19. The method of claim 17, further comprising the steps of placing a GPS device in the subject vehicle and measuring GPS coordinates correlating to regions of identified road surface irregularities.

20. The method of claim 19, further comprising the step of producing a map of road surface irregularities using the measured GPS coordinates.
